(19) United States
(12) Patent Application Publication
(10) Pub. No.: US 2014/0021934 A1
(43) Pub. Date: Jan. 23, 2014

(54) DEVICES AND COMPONENTS FOR POWER CONVERSION CIRCUITS

(71) Applicant: Transphorm, Inc., Goleta, CA (US)

(72) Inventors: Yifeng Wu, Goleta, CA (US); Primit Parikh, Goleta, CA (US)

(21) Appl. No.: 13/803,912

(22) Filed: Mar. 14, 2013

Related U.S. Application Data
(60) Provisional application No. 61/672,723, filed on Jul. 17, 2012.

(51) Int. Cl. H02M 3/156

(52) U.S. Cl. CPC H02M 3/156
USPC 323/311

(57) ABSTRACT

A circuit includes a switching device comprising a control terminal and first and second power terminals, and an inductive element having a first terminal electrically connected to the second power terminal of the switching device. The electronic circuit is configured such that in a first mode of operation, the control terminal of the switching device is biased off, current flows through the inductive element, and the switching device blocks a first voltage. In a second mode of operation, the control terminal of the switching device is biased off, and voltage blocked by the switching device decreases from the first voltage to a second voltage. In a third mode of operation, the control terminal of the switching device is biased on and the current flowing through the inductive element flows through the switching device.

### CROSS-REFERENCE TO RELATED APPLICATIONS

This application claims the benefit and priority of U.S. Provisional Application Ser. No. 61/672,723, filed Jul. 17, 2012, the entire contents of which is hereby incorporated by reference.

### TECHNICAL FIELD

This invention relates to power conversion circuits, such as boost-mode power converters and power factor correction circuits.

### BACKGROUND

Power conversion circuits such as boost-mode power conversion, power factor correction, and bridge circuits are commonly used in a variety of applications. The transistor devices which are used as switches in these applications need to be capable of blocking a voltage at least as large as the circuit high voltage (HV) when they are biased in the OFF state. That is, when the gate-source voltage V_{GS} of any of the transistors is less than the transistor threshold voltage Vₜₕ, no substantial current flows through the transistor when the drain-source voltage V_{DS} (i.e., the voltage at the drain relative to the source) is between 0V and HV. When biased in the ON state (i.e. with V_{GS} greater than the transistor threshold voltage), the transistors conduct the load current, and therefore need to be capable of conducting sufficiently high current for the application in which the circuit is used.

As used herein, the term “blocking a voltage” refers to a transistor, device, or component being in a state for which significant current, such as current that is greater than 0.001 times the average operating current during regular ON-state conduction, is prevented from flowing through the transistor, device, or component when a voltage is applied across the transistor, device, or component. In other words, while a transistor, device, or component is blocking a voltage that is applied across it, the total current passing through the transistor, device, or component will not be greater than 0.001 times the average operating current during regular ON-state conduction.

While power conversion circuits with efficiencies exceeding 90% are fairly common, improvements in the transistor devices, circuit topologies, and/or methods of operation of power circuits are needed to further increase the efficiencies of these circuits.

### SUMMARY

In a first aspect, an electronic circuit is described. The circuit includes a switching device comprising a control terminal and first and second power terminals, and an inductive element having a first terminal electrically connected to the second power terminal of the switching device. The electronic circuit is configured such that in a first mode of operation, the control terminal of the switching device is biased off, current flows through the inductive element, and the switching device blocks a first voltage. In a second mode of operation, the control terminal of the switching device is biased off, and voltage blocked by the switching device decreases from the first voltage to a second voltage. In a third mode of operation, the control terminal of the switching device is biased on and the current flowing through the inductive element flows through the switching device. Additionally, the switching device is configured such that an output capacitance of the switching device while the first and second power terminals are at substantially the same voltage is less than 100 times the output capacitance of the switching device while the device is blocking at least 600V.

In a second aspect, another electronic circuit is described. The circuit includes a switching device comprising a control terminal and first and second power terminals, and an inductive element having a first terminal electrically connected to the second power terminal of the switching device. The electronic circuit is configured such that in a first mode of operation, the control terminal of the switching device is biased off, current flows through the inductive element, and the switching device blocks a first voltage. In a second mode of operation, the control terminal of the switching device is biased off and voltage blocked by the switching device decreases from the first voltage to a second voltage. In a third mode of operation, the control terminal of the switching device is biased on and the current flowing through the inductive element flows through the switching device. Furthermore, the switching device comprises a transistor which includes a conductive channel and lacks any internal p-n junctions in a path of the conductive channel.

In a third aspect, yet another electronic circuit is described. The circuit includes a switching device comprising a control terminal and first and second power terminals, and an inductive element having a first terminal electrically connected to the second power terminal of the switching device. The electronic circuit is configured such that in a first mode of operation, the control terminal of the switching device is biased off, current flows through the inductive element, and the switching device blocks a first voltage. In a second mode of operation, the control terminal of the switching device is biased off, and voltage blocked by the switching device decreases from the first voltage to a second voltage. In a third mode of operation, the control terminal of the switching device is biased on, and the current flowing through the inductive element flows through the switching device. Furthermore, the switching device comprises a transistor having a semiconductor material layer, a source, a gate, and a drain, and the source, gate, and drain are each on a first side of the semiconductor material layer.

In a fourth aspect, a boost-mode power converter circuit is described. The circuit includes a switching device comprising a control terminal and first and second power terminals, and an inductive element having a first terminal electrically connected to the second power terminal of the switching device. The power converter circuit is configured such that in operation, a voltage of the control terminal of the switching device is controlled by a pulsed-width modulated (PWM) voltage supply operating at a frequency. During a first mode of operation of the power converter circuit, the control terminal of the switching device is biased off, and the switching device blocks a first voltage, the first voltage being greater than a circuit input voltage. During a second mode of operation of the power converter circuit, the control terminal of the switching device is biased on, and current flowing through the inductive element flows through the switching device. Additionally, the circuit input voltage is 230V or less, an output voltage of the circuit is at least 400V, the frequency of the PWM voltage supply is greater than 500 kHz, and an efficiency of the power converter circuit is at least 99%.

In a fifth aspect a method of operating an electronic circuit is described. The electronic circuit includes a switching device and an inductive element, the switching device comprises a control terminal and first and second power terminals, and the inductive element has a first terminal electrically connected to the second power terminal of the switching device. The method includes the following steps. During a first time period, the control terminal of the switching device is biased off, causing the switching device to block a first voltage, the first voltage being at least 300V, wherein during the first time period a current flows through the inductive element. During a second time period, the control terminal of the switching device is biased off while voltage blocked by the switching device decreases from the first voltage to a second voltage, the second voltage being less than 200V. The control terminal of the switching device is switched on when voltage across the switching device is equal to the second voltage, causing the current flowing through the inductive element to also flow through the switching device. Furthermore, the switching device is configured such that the stored energy in the output capacitance of the switching device while the switching device is blocking 75V, multiplied by the on-resistance of the switching device at a temperature of 25° C., is less than 0.18 microjoules*ohms.

Circuits and methods described herein can include one or more of the following features. The switching device can comprise a III-Nitride transistor. The III-Nitride transistor can be a depletion-mode transistor, with the switching device further comprising an enhancement-mode transistor having a lower breakdown voltage than the III-nitride transistor, and a source electrode of the III-nitride transistor is electrically connected to a drain electrode of the enhancement-mode transistor. The switching device can comprise a transistor which includes a conductive channel and lacks any internal p-n junctions in a path of the conductive channel. The transistor can be free of p-type semiconductor material. The switching device can be configured such that a stored output capacitance energy of the switching device while the switching device is blocking 75V multiplied by an on-resistance of the switching device at a temperature of 25° C. is less than 0.18 microjoules*ohms. The first voltage can be substantially constant. The first voltage can be 400V or larger and the second voltage can be less than 100V. The circuit can be a power converter circuit. The switching device can be configured to have a breakdown voltage of at least 600V. The circuit can be configured such that in operation, a voltage across the switching device is less than 200V when the control terminal is switched off. The semiconductor material layer can include a III-Nitride channel layer and a III-Nitride barrier layer, wherein a compositional difference between the III-Nitride channel layer and the III-Nitride barrier layer causes a conductive channel to be induced in the III-Nitride channel layer.

Highly efficient power circuits, as well as methods of operating such circuits, are described. The details of one or more implementations of the invention are set forth in the accompanying drawings and description below. Other features and advantages of the invention will be apparent from the description and drawings, and from the claims.

### DESCRIPTION OF DRAWINGS

FIG. 1 illustrates a circuit schematic of a boost-mode power conversion circuit.

FIGS. 2A-2B illustrate a method of operating the circuit of FIG. 1.

FIGS. 3A-3C illustrate another method of operating the circuit of FIG. 1.

FIG. 4 illustrates voltages at a node of a switching device during the method of operation illustrated in FIGS. 3A-3C.

FIG. 5 is a circuit schematic of an electronic component configured for use as a switching device in the circuit of FIG. 1.

FIG. 6 is a cross-sectional view of a semiconductor transistor.

FIG. 7 is a plot of efficiency and PWM frequency versus output power for power conversion circuits.

FIGS. 8A-8B are plots of output capacitance and stored energy, respectively, as a function of voltage for a semiconductor device.

FIGS. 9A-9B are plots of output capacitance and stored energy, respectively, as a function of voltage for another semiconductor device.

Like reference symbols in the various drawings indicate like elements.

### DETAILED DESCRIPTION

Described herein are electronic circuits, e.g., power conversion circuits, and methods of operating electronic circuits, which allow for improved performance as well as extremely high efficiencies. The circuits utilize high-voltage transistors which have reduced low-voltage output capacitances as compared to conventional high-voltage switching devices. Furthermore, the circuits are operated in a soft-switching mode which results in the transistors being switched off under near-zero voltage or low voltage conditions, which reduces electromagnetic interference (EMI) in the circuit. Hence, the effective capacitance being switched when the transistor is switched off is the low-voltage output capacitance. Utilizing transistors with lower low-voltage output capacitance results in reduced switching losses and higher efficiency.

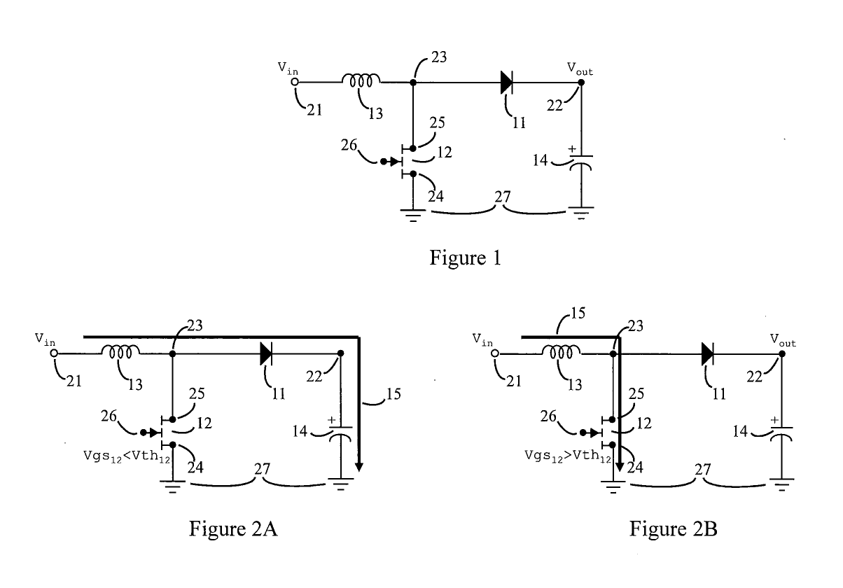

FIG. 1 is a circuit schematic of an exemplary boost-mode power converter (i.e., a boost converter) circuit which takes a voltage (e.g., a constant DC voltage) Vᵢₙ at its input (node 21) and outputs a voltage (e.g., a constant DC voltage) Vₒᵤₜ at its output (node 22), where Vₒᵤₜ is greater than Vᵢₙ. The circuit includes an inductive element 13 (e.g., an inductor), a switching device 12, a rectifying device 11 (e.g., a diode), and a capacitive element 14 (e.g., a capacitor). The inductive element 13 has one terminal electrically connected to input node 12 and an opposite terminal electrically connected to node 23. The rectifying device 11 has one terminal (e.g., an anode) electrically connected to node 23 and an opposite terminal (e.g., a cathode) electrically connected to output node 22. The capacitive element 14 has one terminal electrically connected to output node 22 and an opposite terminal electrically connected to ground 27. The switching device 14 has one terminal 25 electrically connected to node 23 and an opposite terminal 24 electrically connected to ground 27.

As used herein, two or more contacts or other items such as conductive layers or components are said to be “electrically connected” if they are connected by a material which is sufficiently conducting to ensure that the electric potential at each of the contacts or other items is substantially the same or about the same regardless of bias conditions.

The switching device 12 includes power terminals 24 and 25, and control terminal 26. In some implementations, switching device 12 is a single transistor, such as a III-Nitride high electron mobility transistor (HEMT), while in other implementations it is an electronic component which combines a high-voltage depletion mode transistor and a low-voltage enhancement mode transistor in a cascode configuration, such that the electronic component operates substantially the same as a single high-voltage enhancement-mode transistor, as further described below. When switching device 12 is implemented as a single transistor, control terminal 26 is the gate terminal, and terminals 24 and 25 are the source and drain terminals, respectively. Although switching device 26 can be a depletion-mode device (normally on, threshold voltage Vₜₕ<0), the device is typically an enhancement mode device (normally off, threshold voltage Vₜₕ>0) in order to prevent accidental turn on, which may cause damage to the device or other circuit components. The voltage at control terminal 26, which is typically controlled or provided by a pulsed-width modulated (PWM) voltage control source, determines whether input current flows through the rectifying device 11 to the output terminal 22 or is redirected through switching device 12.

A first method of operating the circuit of FIG. 1 is illustrated in FIGS. 2A and 2B. Referring to FIG. 2A, during a first mode of operation, the control terminal 26 of the switching device 12 is biased relative to terminal 24 at a voltage less than the device threshold voltage (i.e., the control terminal 26 of the switching device 12 is biased OFF), and the input current 15 flowing through the inductive element 13 flows through the rectifying device 11 and charges capacitive element 14. In this mode of operation, the voltage at node 23 is slightly higher (typically about 1V higher) than the output voltage Vₒᵤₜ at node 22, and so the switching device 12 blocks a voltage which is slightly greater than Vₒᵤₜ. During this mode, the input current 15 typically is decreasing at approximately a linear rate. Referring to FIG. 2B, during another mode of operation, the control terminal 26 of the switching device 12 is biased relative to terminal 24 at a voltage greater than the device threshold voltage (i.e., the control terminal 26 of the switching device 12 is biased ON), and the input current 15 flowing through the inductive element 13 flows through the switching device 12. In this mode of operation, the voltage at node 23 is close to ground, typically less than a few volts above DC ground, and the rectifying device 11 blocks a voltage which is close to Vₒᵤₜ. During this mode, the input current 15 typically is increasing at approximately a linear rate.

In the method of operation illustrated in FIGS. 2A and 2B, the switching device 12 is switched from OFF to ON while the device is in the first mode of operation (i.e., the switching device 12 is switched ON while device 12 is blocking a voltage), and switching device 12 is switched from ON to OFF while the device is in the second mode of operation (i.e., the switching device 12 is switched OFF while device 12 is conducting a substantially high current). This method of operation is commonly known as “hard-switching”, and switching devices that are switched under these conditions are said to be “hard-switched”.

Alternative circuit configurations which make use of additional passive and/or active components, or alternative methods of operating the circuit of FIG. 1, allow the transistors to be “soft-switched”. A soft-switching circuit configuration is one in which the switching transistors are configured to be switched ON during zero-current (or low current) conditions and/or switched OFF during zero-voltage (or low voltage) conditions. Soft-switching methods and configurations have been developed to address the high levels of electro-magnetic interference (EMI) and associated ringing observed in hard-switched circuits, especially in high current and/or high voltage applications. In some cases, soft-switching can allow a circuit to be switched at a much higher frequency, as compared to hard-switching of the circuit, without incurring unacceptably high levels of EMI, which can result in lower switching losses and therefore higher efficiencies.

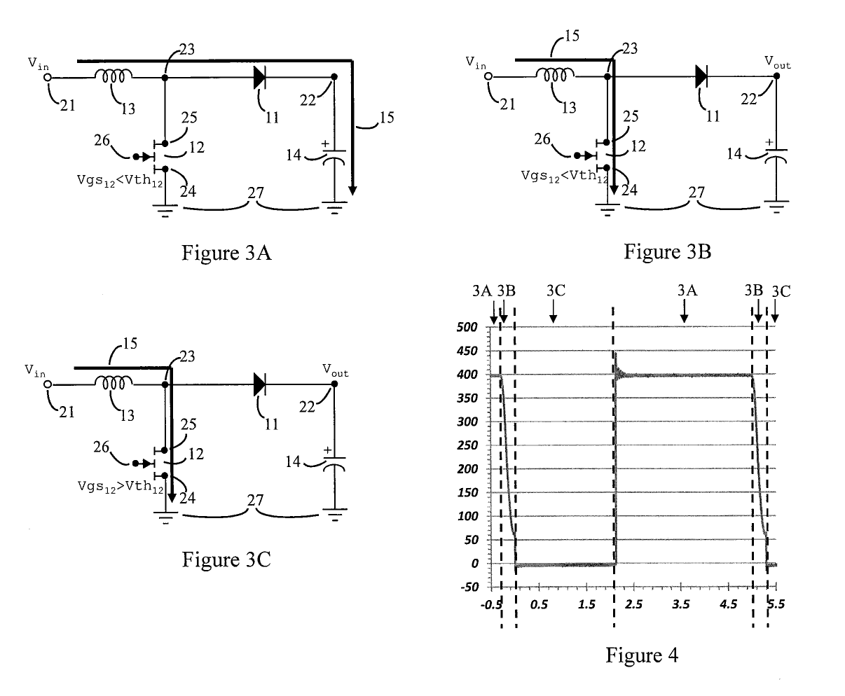

A second method of operating the circuit of FIG. 1, the second method utilizing soft-switching techniques, is illustrated in FIGS. 3A-3C. In this second method, the circuit operates in the mode illustrated in FIG. 3A, followed by the mode illustrated in FIG. 3B, followed by the mode illustrated in 3C, and is then switched back to the mode illustrated in FIG. 3A, with the method repeating itself from there on. The mode of operation illustrated in FIG. 3A is the same as that illustrate in FIG. 2A, with the control terminal 26 of switching device 12 biased OFF and the input current 15 decreasing with time. However, unlike in the method of FIG. 2, the control terminal 26 of the switching device 12 is not switched ON while high current 15 flows through the inductive element 13. Instead, the control terminal 26 of the switching device 12 remains OFF until the input current 15 drops to near zero, at which point the circuit begins to operate in the mode of operation illustrated in FIG. 3B.

Referring to FIG. 3B, once the current 15 drops to near zero, the rectifying device 11 turns OFF, and the voltage at node 23 begins to drop. At this point, the output capacitance of the switching device 12 forms an L-C circuit configuration with the inductive element 13, and the input current 15 as well as the voltage at node 23 begin to oscillate approximately sinusoidally (with a decaying amplitude resulting from resistance in the circuit). For example, in the case where Vₒᵤₜ is about 400V, the voltage at node 23 begins to drop as the output capacitance of switching device 12 charges (or discharges), and the current 15 also oscillates approximately sinusoidally. The maximum current level during this mode of operation is much less than the average or peak current during the mode of operation in FIG. 3A. For example, during the mode of operation illustrated in FIG. 3A, the average or peak input current may be between about 1 A and 5 A, whereas during the mode of operation illustrated in FIG. 3B, the maximum current may be about 100 mA or less.

When the voltage at node 23 reaches its minimum value, which ideally would be about zero volts but is typically larger (for example, when Vₒᵤₜ is about 400V, the minimum value of the voltage at node 23 during these oscillations may be between 50V and 100V), the control terminal 26 of the switching device 12 is switched ON, and the circuit switches into the mode of operation illustrated in FIG. 3C, which is the same as the mode of operation described for FIG. 2B. Hence, switching device 12 is switched ON under low voltage conditions, which results in much lower EMI as compared to switching device 120N while the entire output voltage Vₒᵤₜ is blocked by switching device 12.

FIG. 4 shows a measured plot of the voltage at node 23 (vertical scale) versus time (horizontal scale) for the circuit of FIG. 1 operated as described with reference to FIGS. 3A-3C, where operation in each of the modes in FIGS. 3A, 3B, and 3C are indicated in the figure. As seen, Vₒᵤₜ was about 400V, and so the voltage at node 23 was about 400V during operation in the mode of FIG. 3A. Once the current dropped to near zero, the voltage at node 23 began to drop as the circuit operated in the mode of FIG. 3B. When the voltage at node 23 dropped to between 50V and 100V (typically about 75V), switching device 12 was switched ON, and the voltage at node 23 dropped to near zero. The voltage at node 23 was maintained at a value close to 0V for the entire duration that switching device 12 was kept in the ON state, and increased back to about 400V once switching device 12 was switched OFF again.

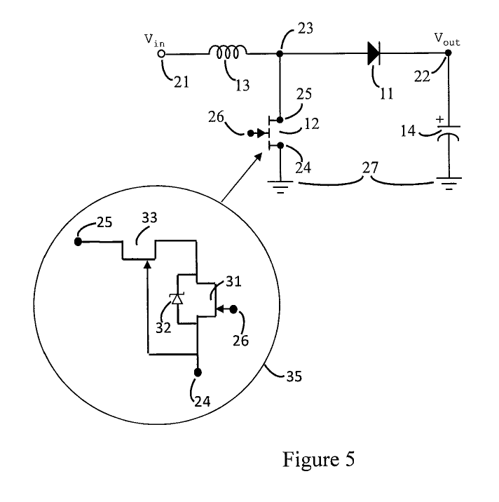

As illustrated in the circuit schematic of FIG. 5, a hybrid enhancement-mode device 35 can be utilized as switching device 12 in the circuit of FIG. 1. The hybrid device 35 includes a high-voltage depletion mode transistor 33, for example a III-Nitride high electron mobility transistor (i.e., a III-N HEMT) connected in a cascode configuration with a low-voltage enhancement-mode transistor 31, for example a silicon-based field-effect transistor (FET). As illustrated in FIG. 5, the source of the high-voltage depletion mode transistor 33 is electrically connected to the drain of the low-voltage enhancement-mode transistor 31, and the gate of the high-voltage depletion mode transistor 33 is electrically connected to the source of the low-voltage enhancement-mode transistor 31. The source of the low-voltage enhancement-mode transistor 31 forms terminal 24 of the hybrid device 35. The gate electrode of the low-voltage enhancement-mode transistor 31 functions as the control terminal 26 of the hybrid device 35. The drain electrode of the high-voltage depletion mode transistor 33 functions as terminal 25 of the hybrid device 35. In this configuration, the hybrid device 35 operates as a single high-voltage enhancement-mode transistor, and in many cases achieves the same or similar output characteristics as a single high-voltage enhancement-mode transistor. The hybrid device 35 was configured to block voltages of up to 600V when in the OFF state.

As used herein, a “hybrid enhancement-mode electronic device or component”, or simply a “hybrid device or component”, is an electronic device or component formed of a depletion-mode transistor and a enhancement-mode transistor, where the depletion-mode transistor is capable of a higher operating and/or breakdown voltage as compared to the enhancement-mode transistor, and the hybrid device or component is configured to operate similarly to a single enhancement-mode transistor with a breakdown and/or operating voltage about as high as that of the depletion-mode transistor. That is, a hybrid enhancement-mode device or component includes at least 3 nodes having the following properties. When the first node (source node) and second node (gate node) are held at the same voltage, the hybrid enhancement-mode device or component can block a positive high voltage (i.e., a voltage larger than the maximum voltage that the enhancement-mode transistor is capable of blocking) applied to the third node (drain node) relative to the source node. When the gate node is held at a sufficiently positive voltage (i.e., greater than the threshold voltage of the enhancement-mode transistor) relative to the source node, current passes from the source node to the drain node or from the drain node to the source node when a sufficiently positive voltage is applied to the drain node relative to the source node. When the enhancement-mode transistor is a low-voltage device and the depletion-mode transistor is a high-voltage device, the hybrid component can operate similarly to a single high-voltage enhancement-mode transistor. The depletion-mode transistor can have a breakdown and/or maximum operating voltage that is at least two times, at least three times, at least five times, at least ten times, or at least twenty times that of the enhancement-mode transistor.

As used herein, the terms III-Nitride or III-N materials, layers, devices, structures, etc., refer to a material, layer, device, or structure comprised of a compound semiconductor material according to the stoichiometric formula AlₓIn_{y}Ga_{z}N, where x+y+z is about 1. III-Nitride materials can also include the group-III element Boron (B). In a III-Nitride or III-N device, such as a transistor or HEMT, the conductive channel can be partially or entirely contained within a III-N material layer.

As used herein, a “high-voltage switching device”, such as a high-voltage transistor, is an electronic device which is optimized for high-voltage switching applications. That is, when the transistor is off, it is capable of blocking high voltages, such as about 300V or higher, about 600V or higher, about 1200V or higher, or about 1700V or higher, and when the transistor is on, it has a sufficiently low on-resistance (R_{ON}) for the application in which it is used, i.e., it experiences sufficiently low conduction loss when a substantial current passes through the device. A high-voltage device can at least be capable of blocking a voltage equal to the high-voltage supply or the maximum voltage in the circuit for which it is used. A high-voltage device may be capable of blocking 300V, 600V, 1200V, 1700V, or other suitable blocking voltage required by the application. In other words, a high-voltage device can block any voltage between 0V and at least Vₘₐₓ, where Vₘₐₓ is the maximum voltage that could be supplied by the circuit or power supply. In some implementations, a high-voltage device can block any voltage between 0V and at least 2*Vₘₐₓ. As used herein, a “low-voltage device”, such as a low-voltage transistor, is an electronic device which is capable of blocking low voltages, such as between 0V and V_{low} (where V_{low} is less than Vₘₐₓ), but is not capable of blocking voltages higher than V_{low}. In some implementations, V_{low} is equal to about |Vₜₕ|, greater than |Vₜₕ|, about 2*|Vₜₕ|, about 3*|Vₜₕ|, or between about |Vₜₕ| and 3*|Vₜₕ|, where |Vₜₕ| is the absolute value of the threshold voltage of a high-voltage transistor, such as a high-voltage-depletion mode transistor, contained within a hybrid component, such as that illustrated in FIG. 5. In other implementations, V_{low} is about 10V, about 20V, about 30V, about 40V, or between about 5V and 50V, such as between about 10V and 40V. In yet other implementations, V_{low} is less than about 0.5*Vₘₐₓ, less than about 0.3*Vₘₐₓ, less than about 0.1*Vₘₐₓ, less than about 0.05*Vₘₐₓ, or less than about 0.02*Vₘₐₓ.

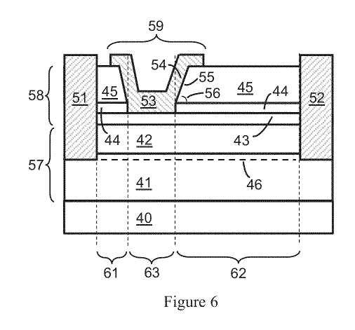

A cross-sectional schematic view of an example III-Nitride HEMT which can be utilized for the high-voltage depletion-mode transistor 33 in FIG. 5 is illustrated in FIG. 6. As shown, the HEMT includes semiconductor material structure 57 which includes a III-N channel layer 41 and a III-N barrier layer 42, the barrier layer 42 having a wider bandgap than the channel layer 41, such that a conductive channel (i.e., a two-dimensional electron gas or 2DEG) 46 is induced in the channel layer 41 adjacent to the barrier layer 42. The III-Nitride channel and barrier layers are optionally formed on a substrate 40, which can be silicon (Si), sapphire, silicon carbide (SiC), GaN, AlN, or any other substrate suitable for the epitaxial growth of III-Nitride semiconductor materials. Source and drain ohmic contacts 51 and 52, respectively, are in ohmic contact with the 2DEG 46. An insulating material structure 58, which includes gate insulator layer 43, etch stop layer 44, and electrode defining layer 45, is formed over the semiconductor material structure 57. The HEMT structure includes a recess through the electrode defining layer 45, and an electrode 59 is formed conformally in the recess. The shape of the electrode 59 is at least partially determined by the profile of the recess. The portion of the electrode 59 that is over the gate region 63 of the semiconductor material structure is the gate 53 of the transistor, and the portion that is over the drain-side access region 62 is a field plate 54.

In the device of FIG. 6, the field plate 54 is implemented as a slant field plate. That is, sidewall 55, which in part defines the shape of the field plate, is at a non-perpendicular angle 56 relative to the uppermost surface of the semiconductor material structure 57. The field plate 54 is electrically connected to the gate 53. The field plate reduces the peak electric field in the device during operation, thereby allowing for higher voltage operation of the device. For example, the field plate can result in the device being able to block voltages as high as 600V or 1200V during operation. Furthermore, the III-N HEMT of FIG. 6 is a lateral device. That is, the source, gate, and drain electrodes 51-53, respectively, are all on the uppermost side of the semiconductor material structure 57, such that in operation all substantial current flows through the channel adjacent to the uppermost side of the semiconductor material structure 57.

Two boost-converter circuits, designed as shown in FIG. 1, were formed and operated in accordance with the soft-switching method illustrated in FIGS. 3A-3C, as previously described. The first circuit utilized a conventional silicon-based CoolMOS enhancement-mode transistor for switching device 12, while the second circuit utilized hybrid device 35 in FIG. 5 for switching device 12. The high-voltage depletion-mode transistor 33 of the hybrid device was the III-N HEMT shown in FIG. 6, and the low-voltage enhancement-mode transistor 31 was a silicon-based FET. The input voltage Vᵢₙ was 230V, and the output voltage Vₒᵤₜ was 400V. The PWM frequency that the control electrode of the switching device 12 was driven at was greater than 200 kHz for output powers less than 600 W, and greater than 500 kHz for output powers less than 200 W. The PWM frequency was adjusted at each output power to ensure that the switching device 12 was being turned ON with minimal voltage across the power terminals. The hybrid device and the CoolMOS transistor were both rated to operate at up to 600V, and the on-resistances of both device were about the same (typical on-resistance for both devices was 0.15 ohms). Hence, it was expected that electrical losses (and therefore the electrical efficiency) in both circuits would be about the same. However, the loss in the circuit with the III-N high voltage transistor was found to be substantially lower than that of the circuit which utilized the silicon-based CoolMOS transistor.

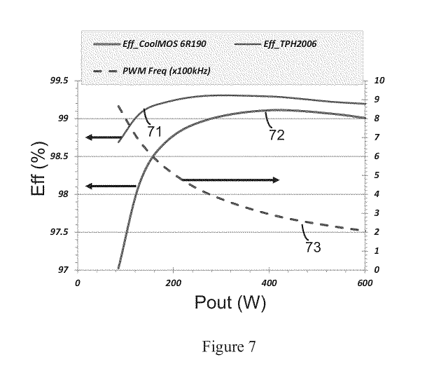

FIG. 7 shows plots of the electrical efficiency as a function of output power for the circuit containing the III-N transistor (curve 71) and the circuit containing the CoolMOS transistor (curve 72). Also plotted is the PWM frequency as a function of output power (curve 73). As seen, the efficiency of the circuit with the III-N high voltage transistor is substantially higher than that of the circuit with the silicon-based CoolMOS transistor. For example, at an output power of 200 W and a PWM frequency of 500 kHz, the efficiency of the circuit with the CoolMOS transistor was about 98.7%, corresponding to a power loss of about 2.6 W, while the efficiency of the circuit with the III-N transistor was about 99.2%, corresponding to a power loss of about 1.6 W. Hence, at 200 W output power, loss in the circuit containing the III-N transistor was reduced by over 35% as compared to loss in the circuit containing the CoolMOS transistor.

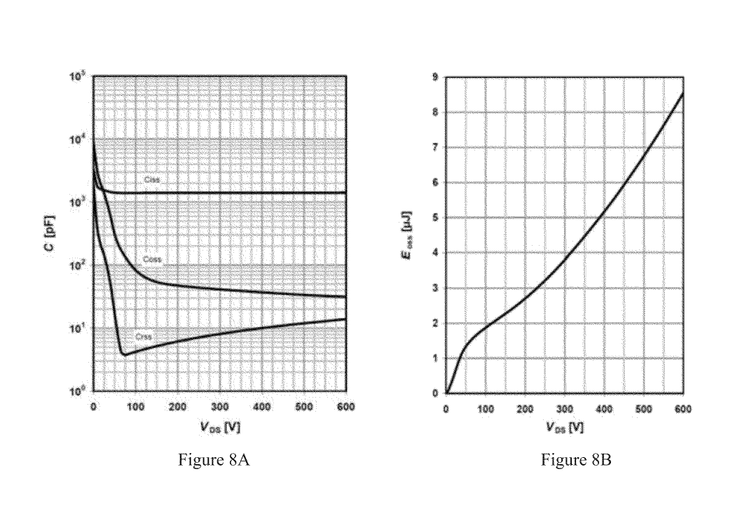

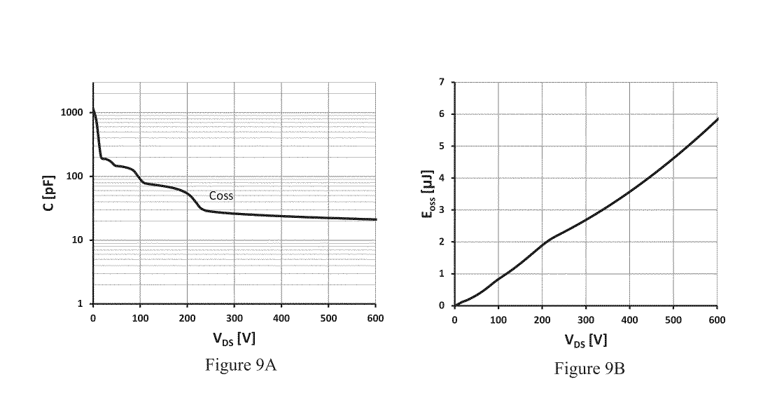

After subsequent investigation, the reduction in loss for the circuit containing the hybrid device, as compared to that containing the CoolMOS, was found to be a result of the reduced low-voltage output capacitance (and corresponding low-voltage capacitive energy storage) of the hybrid device, as compared to that in the CoolMOS transistor. Plots of the output capacitance Cₒₛₛ and capacitive stored energy as a function of drain-source voltage are shown in FIGS. 8A and 8B, respectively, for the CoolMOS transistor, and in FIGS. 9A and 9B, respectively, for the hybrid device. While the high-voltage output capacitance (i.e., the output capacitance with 600V drain-source voltage) of the CoolMOS transistor is only about 2 times higher than that of the hybrid device, the capacitance at 0V source-drain voltage of the CoolMOS transistor is about 10 times higher than that of the hybrid device. Hence, while loss in the circuits may be comparable in applications in which the switching device 12 is hard-switched, such as in the method described with reference to FIGS. 2A-2B, loss in the circuit utilizing the hybrid device are substantially lower than in that utilizing the CoolMOS transistor in applications in which the switching device 12 is soft-switched, such as in the method described with reference to FIGS. 3A-3C.

The reduced low-voltage output capacitance in the hybrid component, as compared to that of the CoolMOS transistor, results from structural differences between the CoolMOS transistor and the III-Nitride high-voltage transistor utilized in the hybrid device. As described earlier, the III-Nitride transistor is a lateral device, having its source and drain electrodes on the same side of the semiconductor material structure. In contrast, the CoolMOS transistor, like other typical high-voltage transistors, is a vertical device, having the source on an opposite side of the semiconductor material from the drain. As a result, the CoolMOS transistor tends to have a higher output capacitance as compared to the III-Nitride transistor. Furthermore, the CoolMOS transistor, which is a type of device known as a silicon super junction device, utilizes a large effective area p-n junction in the path of the device channel in the drift region of the drain (i.e., the region of the semiconductor material between the gate and the drain), which enables a high doping density and therefore a higher carrier density, while at the same time allowing the device to achieve the desired high voltage OFF-state operation. These p-n junctions are substantially depleted under high voltage operating conditions, and therefore do not substantially increase the device output capacitance at high voltages. However, at lower voltages, for which the depletion regions in the p-n junctions are much narrower, the additional output capacitance resulting from the inclusion of these p-n junctions is substantial. The III-N transistor used in the hybrid device does not include a p-n junction in the path of the channel between the gate and the drain, and in the implementation shown in FIG. 6 does not include any p-type material (and therefore does not include any p-n diodes) in the semiconductor material.

A number of advantages of the hybrid device, as compared to the CoolMOS transistor, for the soft-switching method of operation of the circuit of FIG. 1 are as follows. As shown in FIG. 9A, the output capacitance of the hybrid device while the first and second power terminals are at substantially the same voltage (e.g., the low-voltage capacitance) is about 1155 picofarads, which is less than 100 times larger than 22 picofarads, the output capacitance while the hybrid device is blocking at least 600V. For, the CoolMOS transistor, ss shown in FIG. 8A, the output capacitance while the first and second power terminals are at substantially the same voltage (e.g., the low-voltage capacitance) is close to 10,000 picofarads, which is more than 5 times the low-voltage capacitance of the hybrid device and approximately 300 times larger than the output capacitance while the device is blocking at least 600V (which is about 30 picofarads). As can be calculated from FIG. 9B, the stored output capacitance energy of the hybrid device while the device is blocking 75V (i.e., the approximate voltage being blocked when the device is switched ON) multiplied by the on-resistance of the switching device at a temperature of 25° C. is less than 0.18 microjoules*ohms (the output capacitance is typically inversely proportional to the on-resistance). For the CoolMOS transistor, the product of these two factors is approximately 0.24 microjoules*ohms. As seen in FIG. 7, the circuit with the hybrid device can have an input voltage of 230V or less, an output voltage of 400V or larger, and can be operated with a PWM frequency of at least 500V and an efficiency greater than 99%. For the circuit with the CoolMOS transistor, the highest efficiency under such conditions is about 98.8%. Additionally, power loss in the circuit with the hybrid device can be less than 2 W for an output power greater than 200 W and a PWM frequency greater than 400 kHz for an input voltage of 230V or less and an output voltage of 400V or larger. For the circuit with the CoolMOS transistor, the minimum power loss under such conditions is about 2.5 W, which is more than 25% higher than the circuit with the hybrid device.

A number of implementations have been described. Nevertheless, it will be understood that various modifications may be made without departing from the spirit and scope of the techniques and devices described herein. For example, a high-voltage enhancement-mode III-Nitride transistor, which can be formed as a lateral device, can be used in place of the hybrid device for switching device 12. Because a high-voltage enhancement-mode III-Nitride transistor can be formed as a lateral device and also lacks any p-n junctions along the path of current flow, it is expected to provide the same or similar advantages to those described for the hybrid device. Accordingly, other implementations are within the scope of the following claims.

What is claimed is:

1. An electronic circuit, comprising:
a switching device comprising a control terminal and first and second power terminals; and
an inductive element having a first terminal electrically connected to the second power terminal of the switching device; wherein
the electronic circuit is configured such that in a first mode of operation the control terminal of the switching device is biased off, a current flows through the inductive element, and the switching device blocks a first voltage, in a second mode of operation the control terminal of the switching device is biased off and voltage blocked by the switching device decreases from the first voltage to a second voltage, and in a third mode of operation the control terminal of the switching device is biased on and the current flowing through the inductive element flows through the switching device; and
the switching device is configured such that an output capacitance of the switching device while the first and second power terminals are at substantially the same voltage is less than 100 times the output capacitance of the switching device while the device is blocking at least 600V.

2. The electronic circuit of claim 1, wherein the switching device comprises a III-Nitride transistor.

3. The electronic circuit of claim 2, wherein the III-Nitride transistor is a depletion-mode transistor, the switching device further comprises an enhancement-mode transistor having a lower breakdown voltage than the III-nitride transistor, and a source electrode of the III-nitride transistor is electrically connected to a drain electrode of the enhancement-mode transistor.

4. The electronic circuit of claim 1, wherein the switching device comprises a transistor which includes a conductive channel and lacks any internal p-n junctions in a path of the conductive channel.

5. The electronic circuit of claim 4, wherein the transistor is free of p-type semiconductor material.

6. The electronic circuit of claim 1, wherein the switching device is configured such that a stored output capacitance energy of the switching device while the switching device is blocking 75V multiplied by an on-resistance of the switching device at a temperature of 25° C. is less than 0.18 microjoules*ohms.

7. The electronic circuit of claim 1, wherein the first voltage is substantially constant.

8. The electronic circuit of claim 1, wherein the first voltage is 400V or larger and the second voltage is less than 100V.

9. An electronic circuit, comprising:
a switching device comprising a control terminal and first and second power terminals; and
an inductive element having a first terminal electrically connected to the second power terminal of the switching device; wherein
the electronic circuit is configured such that in a first mode of operation the control terminal of the switching device is biased off, a current flows through the inductive element, and the switching device blocks a first voltage, in a second mode of operation the control terminal of the switching device is biased off and voltage blocked by the switching device decreases from the first voltage to a second voltage, and in a third mode of operation the control terminal of the switching device is biased on and the current flowing through the inductive element flows through the switching device; and
the switching device comprises a transistor which includes a conductive channel and lacks any internal p-n junctions in a path of the conductive channel.

10. The electronic circuit of claim 9, wherein the transistor is a III-Nitride transistor.

11. The electronic circuit of claim 9, wherein the circuit is a power converter circuit.

12. The electronic circuit of claim 9, wherein the switching device is configured to have a breakdown voltage of at least 600V.

13. A method of operating an electronic circuit comprising a switching device and an inductive element, the switching device comprising a control terminal and first and second power terminals, and the inductive element having a first terminal electrically connected to the second power terminal of the switching device, the method comprising:
during a first time period biasing the control terminal of the switching device off, causing the switching device to block a first voltage, the first voltage being at least 300V, wherein during the first time period a current flows through the inductive element;
during a second time period biasing the control terminal of the switching device off while voltage blocked by the switching device decreases from the first voltage to a second voltage, the second voltage being less than 200V; and
switching the control terminal of the switching device on when voltage across the switching device is equal to the second voltage, causing the current flowing through the inductive element to also flow through the switching device; wherein
the switching device is configured such that a stored energy in an output capacitance of the switching device while the switching device is blocking 75V, multiplied by an on-resistance of the switching device at a temperature of 25° C., is less than 0.18 microjoules*ohms.

14. The method of claim 13, wherein the switching device comprises a III-Nitride transistor.

15. A boost-mode power converter circuit, comprising:
a switching device comprising a control terminal and first and second power terminals;
an inductive element having a first terminal electrically connected to the second power terminal of the switching device; wherein
the power converter circuit is configured such that in operation, a voltage of the control terminal of the switching device is controlled by a pulsed-width modulated (PWM) voltage supply operating at a frequency;
during a first mode of operation of the power converter circuit the control terminal of the switching device is biased off and the switching device blocks a first voltage, the first voltage being greater than a circuit input voltage;
during a second mode of operation of the power converter circuit the control terminal of the switching device is biased on and current flowing through the inductive element flows through the switching device;
the circuit input voltage is 230V or less, and an output voltage of the circuit is at least 400V;
the frequency of the PWM voltage supply is greater than 500 kHz; and
an efficiency of the power converter circuit is at least 99%.

16. The power converter circuit of claim 15, wherein the power converter circuit is configured such that in operation, a voltage across the switching device is less than 200V when the control terminal is switched off.

17. The power converter circuit of claim 15, wherein the switching device comprises a III-Nitride transistor.

18. An electronic circuit, comprising:
a switching device comprising a control terminal and first and second power terminals; and
an inductive element having a first terminal electrically connected to the second power terminal of the switching device; wherein
the electronic circuit is configured such that in a first mode of operation the control terminal of the switching device is biased off, a current flows through the inductive element, and the switching device blocks a first voltage, in a second mode of operation the control terminal of the switching device is biased off and voltage blocked by the switching device decreases from the first voltage to a second voltage, and in a third mode of operation the control terminal of the switching device is biased on and the current flowing through the inductive element flows through the switching device; and
the switching device comprises a transistor having a semiconductor material layer, a source, a gate, and a drain, wherein the source, gate, and drain are each on a first side of the semiconductor material layer.

19. The electronic circuit of claim 18, the semiconductor material layer comprising a III-Nitride channel layer and a III-Nitride barrier layer, wherein a compositional difference between the III-Nitride channel layer and the III-Nitride barrier layer causes a conductive channel to be induced in the III-Nitride channel layer.
